(19) United States
(12) Patent Application Publication
(10) Pub. No.: US 2010/0090181 A1
(43) Pub. Date: Apr. 15, 2010

(54) FLEXIBLE AND/OR RIGID PHOTOCHROMIC ITEMS FOR PACKAGING ITEMS SENSITIVE TO LIGHT

(75) Inventor: Burkhard Wehefritz, Mainz (DE)

Correspondence Address: BASELL USA INC., NEWTOWN SQUARE CENTER, 3801 WEST CHESTER PIKE, BLDG. B, NEWTOWN SQUARE, PA, 19073, US

(73) Assignee: Basell Polyolefine GmbH, Wesseling (DE)

(21) Appl. No.: 12/449,363

(22) PCT Filed: Jan. 23, 2008
(86) PCT No.: PCT/EP2008/050753

§ 371 Date: Aug. 4, 2009

Related U.S. Application Data
(60) Provisional application No. 60/901,102, filed on Feb. 13, 2007.

(30) Foreign Application Priority Data
Feb. 6, 2007 (EP) 07101773.5

(51) Int. Cl. G02B 5/23

(52) U.S. Cl. 252/586

(57) ABSTRACT

Use for packaging items sensitive to light of a polymer composition in the form of film or moulded articles comprising a polymeric resin and one or more photochromic additive.

The present invention relates to the use of polyolefins resins, flexible (e.g. films) or rigid (e.g. injection moulded, blow moulded, thermoformed etc.), especially polyethylene and polypropylene-based, containing a photochromic additive.

Photochromic additives comprise molecules able to change the color due to a transformation of a chemical species induced by daylight or UV ray. These molecules have found several fields of application especially in plastics (e.g. ophthalmic lenses).

US 2003/0008409 relates to an apparatus for the determination of the amount of sunlight a certain location receives. It consists in a device substrate in which the photochromic compounds are coated. US 2001/0009721 relates to a photochromic film able to retain the photochromic activity for a long time.

WO2005/030856 relates to a new photochromic systems that can be used for the production of moldings, rotomolded articles, injection molded articles, films etc.

From another point of view packaging of food, (or other packaged items sensitive to light), requires to be transparent in order to see the food, (or other packaged items sensitive to light), inside the package (such as meat or vegetables or indeed cosmetic products) and they are at the same time damaged from the exposition of the daylight.

Therefore the use of polymer items containing photochromic additives would resolve two problems. The first one is that the photochromic additives by absorbing a significant amount of energy over a wide range of wavelengths covering especially the UV light range, reduce the exposure of food, (or other packaged items sensitive to light), to such potentially damaging radiations. The second problem solved is that, in the activated stage depending on the specific additive used, a particular part of the light spectrum is much more strongly absorbed resulting in a reversible formation of a color thus providing a visible indication of the exposure of the items sensitive to light such as food to a potentially damaging lightsource.

Therefore an object of the present invention is the use for packaging of items sensitive to light of a polymer composition in the form of film and/or molded articles (such as trays tank, containers, bottles and the like) comprising a polymeric resin and a photochromic additive.

Preferred items to be packages are foods, cosmetics or drugs. More preferably items to be packaged are meat, fish, or cheese.

The polymeric resin to be used in the polymer composition can be any resin or mixture of different resins able to give a flexible (e.g. film) and/or rigid (e.g. injection moulded, blow moulded, thermoformed etc.) item having the features required for the packaging of the items sensitive to light such as foods, cosmetics or drugs.

Particularly preferred resins are polyolefin-based resins such as polyl-butene based resins, polypropylene based resins and polyethylene based resins. Particularly preferred are propylene-based resins particularly preferred are polypropylene-based resins providing a combination of high transparency, and high purity.

Due to the particular features such as transparency and very limited amount of hexane extractables the propylene-based resins obtained by the use of metallocene-based catalyst are particularly preferred. Additionally these resins can demonstrate an exceptional combination of high stiffness and transparency which provides opportunities for downgauging the thickness of the packaging item whilst maintaining its mechanical properties or a combination of cold temperature impact and transparency which is desirable to maintain the physical integrity of a packaging items, while still allowing to see the packaged goods. Isotactic resins obtained by using metallocene-based catalyst system are more preferred. The term isotactic means that the isotactic pentads mmmm measured by NMR are higher than 80%.

In Particular propylene-based resins are homo- or copolymers of propylene or blends of homo- and copolymers or blends between two different copolymers. Ethylene and 1-butene are the preferred comonomers, ethylene is especially preferred.

The photochromic material is not specifically limited but may be chosen from any known types. Specific examples may include organic photochromic materials such as azobenzene compounds, thioindigo compounds, spiropyran compounds, fulgide compounds, triphenylmethane compounds, spirooxazine compounds, viologen compounds, salicyldineanil compounds, etc.

The amount of photochromic dye in the polymeric material usually is in the range of about 0.001 to 10% by weight, most preferably 0.01 to 5% by weight, with respect to the total weight of the polymeric material. The polymeric material can contain mixtures of two or more photochromic dyes.

The resin used in the present invention generally further comprises customary amounts of additives known to those skilled in the art, e.g. stabilizers, lubricants and mold release agents, fillers, nucleating agents, antistatics, plasticizers, dyes, pigments, anti-fungal, anti-microbial agents, film cavitating agents or flame retardants. In general, these are incorporated during granulation of the pulverulent product obtained in the polymerization.

Customary stabilizers include antioxidants such as sterically hindered phenols, sterically hindered amines or UV stabilizers, processing stabilizers such as phosphites or phosphonites, acid scavengers such as calcium stearate or zinc stearate or dihydrotalcite, as well as calcium, zinc and sodium caprylate salts. In general, the propylene copolymer compositions of the present invention contain one or more stabilizers in amounts of up to 2% by weight.

Suitable lubricants and mold release agents are, for example, fatty acids, calcium, sodium or zinc salts of fatty acids, fatty acid amides or low molecular weight polyolefin waxes, which are usually used in concentrations of up to 2% by weight.

Possible fillers are, for example, talc, calcium carbonate, chalk or glass fibers, and these are usually used in amounts of up to 50% by weight.

Examples of suitable nucleating agents are inorganic additives such as talc, silica or kaolin, salts of monocarboxylic or polycarboxylic acids, e.g. sodium benzoate or aluminum tert-butylbenzoate, dibenzylidenesorbitol or its C₁-C₈-alkyl-substituted derivatives such as methyldibenzylidenesorbitol, ethyldibenzylidenesorbitol or dimethyldibenzylidenesorbitol or salts of diesters of phosphoric acid, e.g. sodium 2,2′-methylenebis(4,6,-di-tert-butylphenyflphosphate. The nucleating agent content of the propylene copolymer composition is generally up to 5% by weight.

Such additives are generally commercially available and are described, for example, in Gächter/Müller, Plastics Additives Handbook, 4th Edition, Hansa Publishers, Munich, 1993.

The additives/components of the invention and optional further components may be added to the polymer material individually or mixed with one another. If desired, the individual components can be mixed with one another before incorporation into the polymer for example by dry blending, compaction or in the melt. The incorporation of the components of the invention and optional further components into the polymer is carried out by known methods such as dry blending in the form of a powder, or wet mixing in the form of solutions, dispersions or suspensions for example in an inert solvent, water or oil. The additives of the invention and optional further additives may be incorporated, for example, before or after molding or also by applying the dissolved, melted (soaking process) or dispersed additve or additive mixture to the polymer material, with or without subsequent evaporation of the solvent or the suspension/dispersion agent. They may be added directly into the processing apparatus (e.g. extruders, internal mixers, etc), e.g. as a dry mixture or powder or as solution or dispersion or suspension or melt. The incorporation can be carried out in any heatable container equipped with a stirrer, e.g. in a closed apparatus such as a kneader, mixer or stirred vessel. The incorporation is preferably carried out in an extruder or in a kneader. It is immaterial whether processing 10 takes place in an inert atmosphere or in the presence of oxygen.

The addition of the additive or additive blend to the polymer can be carried out in all customary mixing machines in which the polymer is melted and mixed with the additives. Suitable machines are known to those skilled in the art. They are predominantly mixers, kneaders and extruders. The process is preferably carried out in an extruder by introducing the additive during processing.

Particularly preferred processing machines are single-screw extruders, contrarotating and corotating twin-screw extruders, planetary-gear extruders, ring extruders or cokneaders. It is 20 also possible to use processing machines provided with at least one gas removal compartment to which a vacuum can be applied. Suitable extruders and kneaders are described, for example, in Handbuch der Kunststoffextrusion, Vol. I Grundlagen, Editors F. Hensen, W. Knappe, H. Potente, 1989, pp. 3-7, ISBN:3-446-74339-4 (Vol. 2 Extrusionsanlagen 1986, ISBN 3-446-14329-7).

For example, the screw length is 1-60 screw diameters, preferably 35-48 screw diameters. The rotational speed of the screw is preferably 10-600 rotations per minute (rpm), very particularly preferably 25-300 rpm.

The maximum throughput is dependent on the screw diameter, the rotational speed and the driving force. The process of the present invention can also be carried out at a level lower 30 than maximum throughput by varying the parameters mentioned or employing weighing machines delivering dosage amounts. Components to be added can be premixed or added individually.

Examples of the use of the resin of the present invention are films for, trays, baskets food, foods cosmetics or drugs containers and caps and the like.

1-8. (canceled)

9. A photochromic polyolefin composition comprising at least one polyolefin resin and at least one photochromic additive.

10. The photochromic polyolefin composition of claim 9, wherein the polyolefin resin is a polypropylene-based resin, the polypropylene-based resin being selected from a polypropylene homopolymer, a polypropylene copolymer, or mixtures thereof.

11. The photochromic polyolefin composition of claim 10, wherein the polypropylene copolymer comprises a comonomer selected from ethylene, 1-butene, and mixtures thereof.

12. The photochromic polyolefin composition of claim 9, wherein the polyolefin resin is obtained by a polymerization process comprising a metallocene-based catalyst system.

13. The photochromic polyolefin composition of claim 9, wherein the photochromic additive is present ranging from about 0.001 to 10% by weight.

14. The photochromic polyolefin composition of claim 9, wherein the photochromic additive is present ranging from about 0.001 to 10% by weight.

15. The photochromic polyolefin composition of claim 9, wherein the photochromic additive is selected from azobenzene compounds, thioindigo compounds, spiropyran compounds, fulgide compounds, triphenylmethane compounds, spirooxazine compounds, viologen compounds, salicyldineanil compounds, and mixtures thereof.

16. A process for packaging items sensitive to light, the process comprising packaging the items using a film or molded article, wherein the film or molded article comprises a photochromic polyolefin composition, the photochromic polyolefin composition comprising at least one pol yolefin resin and at least one photochromic additive.

17. A method for producing a photochromic polyolefin composition for food, health care, or cosmetic packaging, wherein the photochromic polyolefin composition absorbs radiation in the UV light spectrum and produces a reversible color change within the photochromic polyolefin composition, the method comprising adding about 0.001 to 10% by weight of at least one photochromic additive to at least one polyolefin resin.

18. The method of claim 17, wherein the polyolefin resin is a polypropylene-based resin, the polypropylene-based resin being selected from a polypropylene homopolymer, a polypropylene copolymer, or mixtures thereof

19. The method of claim 18, wherein the polypropylene copolymer comprises a comonomer selected from ethylene, 1-butene, and mixtures thereof

20. The method of claim 17, wherein the polyolefin resin is obtained by a polymerization process comprising a metallocene-based catalyst system.

21. The method of claim 17, wherein the photochromic additive is present ranging from about 0.001 to 10% by weight.

22. The method of claim 17, wherein the photochromic additive is present ranging from about 0.001 to 10% by weight.

23. The method of claim 17, wherein the photochromic additive is selected from azobenzene compounds, thioindigo compounds, spiropyran compounds, fulgide
